(19) United States
(12) Patent Application Publication
(10) Pub. No.: US 2026/0286105 A1
(43) Pub. Date: Sep. 24, 2026

(54) Bioplastics And Method Of Formation

(71) Applicant: Viable Gear, Inc., Portland, ME (US)

(72) Inventor: Katie Moran Weiler, Portland, ME (US)

(21) Appl. No.: 19/571,573

(22) Filed: Mar. 19, 2026

Related U.S. Application Data
(60) Provisional application No. 63/776,028, filed on Mar. 22, 2025.

(51) Int. Cl. C08L 5/04; B29B 9/06; B29B 9/10; B29B 9/12; C09D 7/63; C09D 7/65; C09D 105/04; D01D 5/06; D01F 9/04; B29K 105/24

(52) U.S. Cl. CPC C08L 5/04; B29B 9/06; B29B 9/10; B29B 9/12; C09D 7/63; C09D 7/65; C09D 105/04; D01D 5/06; D01F 9/04; B29K 2005/00; B29K 2105/24; C08L 2203/12; C08L 2203/16; C08L 2205/025; C08L 2205/03; C08L 2205/035; C08L 2205/06; C08L 2205/16; C08L 2207/322; C08L 2312/00

(57) ABSTRACT

An algae-derived bioplastic formulation is disclosed in the form of a viscous, processable dope suitable for extrusion, spinning, casting, coating, or molding, with at least 50 wt. % of non-water solids derived directly or indirectly from macroalgae or microalgae biomass, the dope using an algae-derived polysaccharide matrix that includes alginate.

### BACKGROUND INFORMATION

### Field of the Invention

The invention relates to bioplastic devices that mimic the characteristics of petroleum-based plastic products such as cordage, textiles, films, coatings, and thermoplastics products

### Discussion of Prior Art

The pervasive use of petroleum-based plastics has led to significant environmental challenges, particularly in the form of plastic pollution. These materials, widely used in industries such as packaging, textiles, automotive, and consumer goods, persist in the environment for extended periods, in many cases existing in perpetuity, due to their resistance to natural degradation processes. Notably, the accumulation of plastic waste in the world's oceans has raised concerns about its impact on marine ecosystems and biodiversity. Efforts to mitigate plastic pollution have led to increased demand for alternative materials that offer similar functional characteristics to conventional plastics but with enhanced biodegradability and reduced environmental impact.

Bioplastics, which may be derived from renewable biomass sources such as plant-based materials, have emerged as a promising solution to replace petroleum-based plastics. However, despite significant advancements, many bioplastics still face limitations in mimicking the performance characteristics of petroleum-derived products, particularly in applications requiring high strength, flexibility, durability, and thermal stability. For instance, products such as cordage, textiles, and molded thermoplastics articles are essential to industries ranging from agriculture and fashion to commercial fishing, yet existing bioplastic alternatives often fail to replicate the mechanical properties, ease of processing, or long-lasting durability of their petroleum-based counterparts.

Additionally, the widespread adoption of bioplastics has been hindered by challenges related to cost, scalability, and material properties, which must be tailored to specific applications without compromising environmental benefits. There exists a need for a bioplastic composition that closely mimics the characteristics of petroleum-based materials used in cordage, textiles, and thermoplastics, while providing a sustainable, compostable, biodegradable alternative that can reduce the amount of plastic waste, particularly in marine environments.

The present invention seeks to address these needs by providing a novel bioplastic formulation that effectively emulates the desirable properties of conventional plastics, while offering enhanced environmental advantages, including the ability to degrade naturally in marine and/or soil conditions. This innovation aims to significantly reduce the environmental footprint of plastic waste and promote the transition toward more sustainable materials in various industrial applications

### BRIEF SUMMARY OF THE INVENTION

The invention is a compounded formula from algae, specifically macroalgae and microalgae, that, when subjected to specific manufacturing processes, is rendered into bioplastic products that mimic the characteristics of petroleum-based plastic products such as cordage, textiles, and thermoplastics.

The compounded formulation is a viscous processable dope containing macro and or micro polysaccharides, and at least one bio-based plasticizer derived from algae, which sets it apart from other seaweed-based bioplastics, wherein the composition is predominantly algae-derived and biodegradable, marine compostable, and overall better for the environment as an alternative to petroleum-based plastics.

The formulation further comprises algae-derived nanocellulose, including nanofibers, microfibrillated cellulose, and/or nanocrystalline cellulose, in modified or unmodified form. The interaction between the nanocellulose and the polysaccharide matrix enhances mechanical reinforcement and moisture resistance of the composite material. Further, as an entirely algae-based material it: 1) is not made from petroleum-based sources; and 2) it decomposes naturally without the intervention of industrial grade machinery.

Additionally, the nanocellulose from seaweed enhances mechanical properties and processability of the composite. In certain embodiments, the nanocellulose is obtained from a by-product stream of an alginate production process and is subjected to mechanical, chemical, and/or enzymatic treatment to extract and refine nanoscale cellulose structures

In certain embodiments, the algae-derived nanocellulose comprises fibrillar or crystalline cellulose structures having at least one dimension in the nanoscale range. In some embodiments, the nanocellulose possesses an average fibril or particle width of approximately 2 nm to 100 nm, and in certain embodiments 3 nm to 60 nm, as measured by microscopy techniques including Transmission Electron Microscopy, Atomic Force Microscopy, or Scanning Electron Microscopy. In various embodiments, fibril lengths range from approximately 50 nm to 20 µm, resulting in an aspect ratio (length-to-width) of approximately 10:1 to 500:1 or greater. In some embodiments, the nanocellulose comprises Cellulose nanofibrils, Cellulose nanocrystals, or combinations thereof. The nanocellulose may exhibit a crystallinity index of approximately 50% to 95%, and in certain embodiments 60% to 90%, as determined by X-ray Diffraction or Solid-state NMR spectroscopy. In certain embodiments, the nanocellulose exhibits a specific surface area of approximately 50 m²/g to 500 m²/g, as measured using BET surface area analysis, thereby providing enhanced interfacial interaction with the polysaccharide matrix.

The nanocellulose may be present in modified or unmodified form. In unmodified form, the surface chemistry is dominated by cellulose hydroxyl functional groups (–OH). In modified embodiments, the nanocellulose surface may include functional groups selected from carboxylate, aldehyde, sulfate ester, phosphate, or other oxidized or derivatized groups, introduced through oxidation, esterification, or other chemical modification processes. In certain embodiments, the nanocellulose exhibits a surface charge density of approximately 0.01 mmol/g to 2.0 mmol/g, as determined by conductometric titration or related analytical methods

Unless otherwise specified, the nanocellulose used herein may be obtained from algal biomass through mechanical fibrillation, enzymatic treatment, acid hydrolysis, oxidative processing, or combinations thereof, and may include both individualized nanoscale fibrils and partially aggregated fibrillar bundles provided that at least a portion of the cellulose structures possess nanoscale dimensions as described above.

The inventive formula is well suited for a wet spinning manufacturing process, which may be used to produce fibers from polymer solutions and/ or suspensions. In certain embodiments, the compounded polymer is extruded through one or more spinnerets into a coagulation bath of multivalent ions. The ions can be derived from salts, but not limited to, calcium, strontium, magnesium and other ionic crosslinking reagents. Upon contact with the coagulation bath, the ions diffuse into the extruded dope and induce ionic crosslinking within the polymer matrix

Once the fibers are formed and dried, they may be spooled to then be used for things such as textile fibers, yarns, or cordage. More specifically, the fibers may be fed into a twisting machine as a means to hold the fibers together, enhancing the strength of the fibers and forming it into a twine/cordage/yarn etc. that have multiple plies. The fibers may also be fed into a braiding machine to be used for twine/cordage/yarn etc. with multiple ends.

In certain embodiments, the crosslinker is incorporated in a latent form and released within the polymer matrix at high temperatures. The polymer may be shaped via extrusion or molding.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 s a dope composition block diagram.

FIG. 2 s pathways overview illustrating various methods of using the dope.

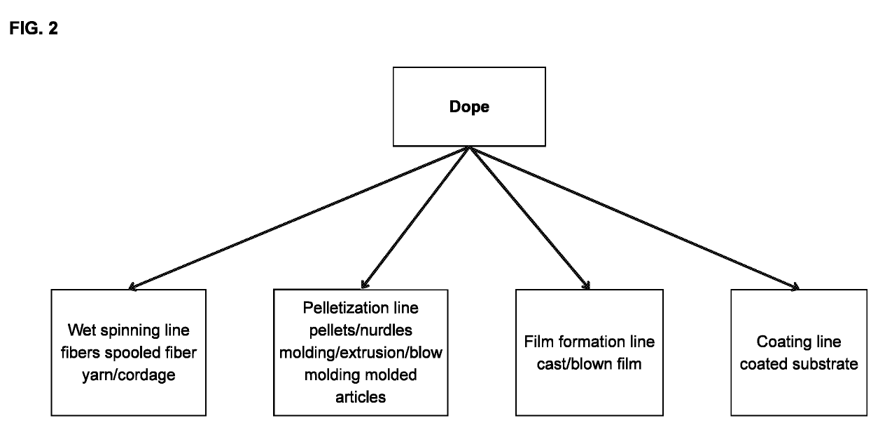

FIG. 3 s a wet spinning process flow diagram.

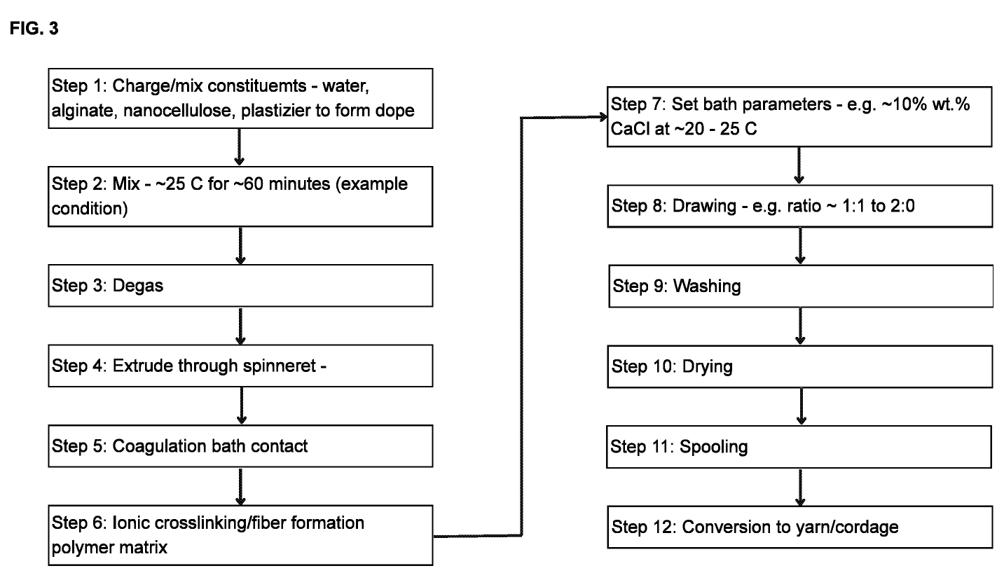

FIG. 4 s a pelletization process flow diagram

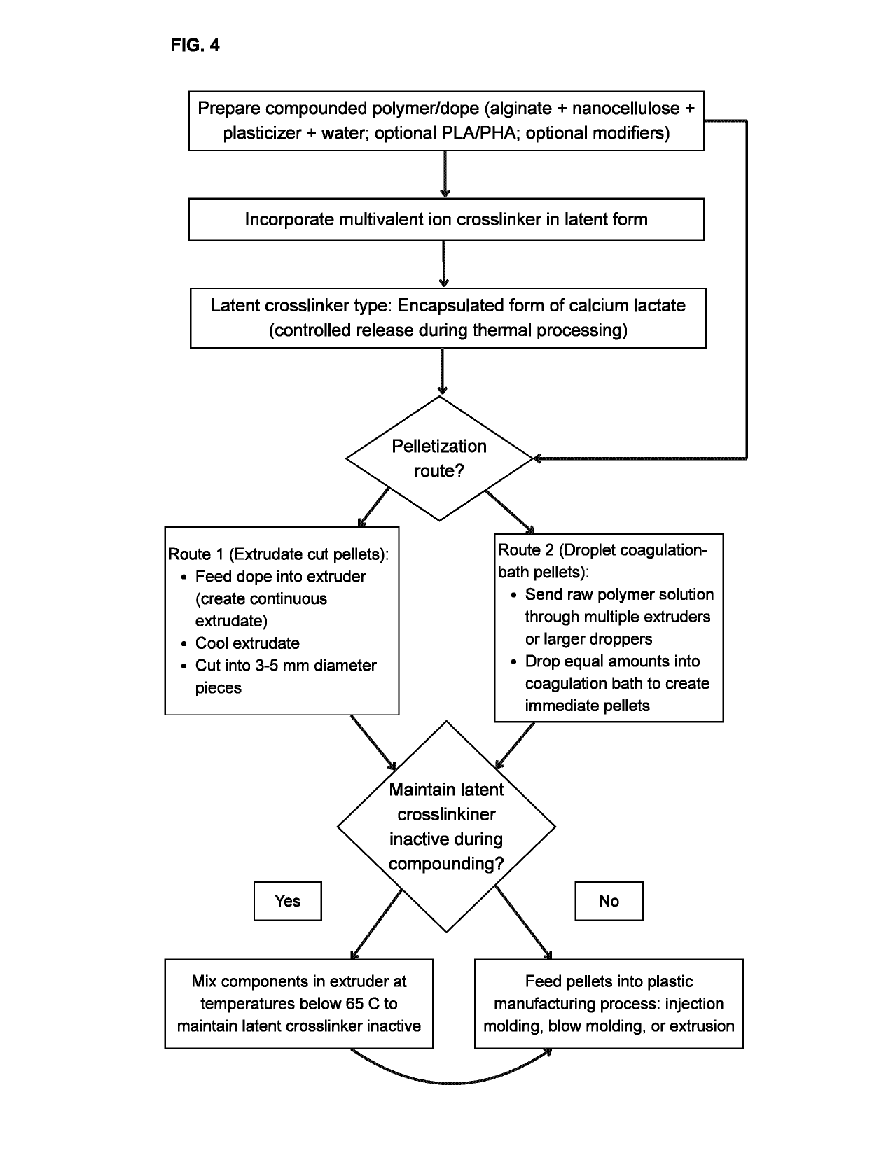

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

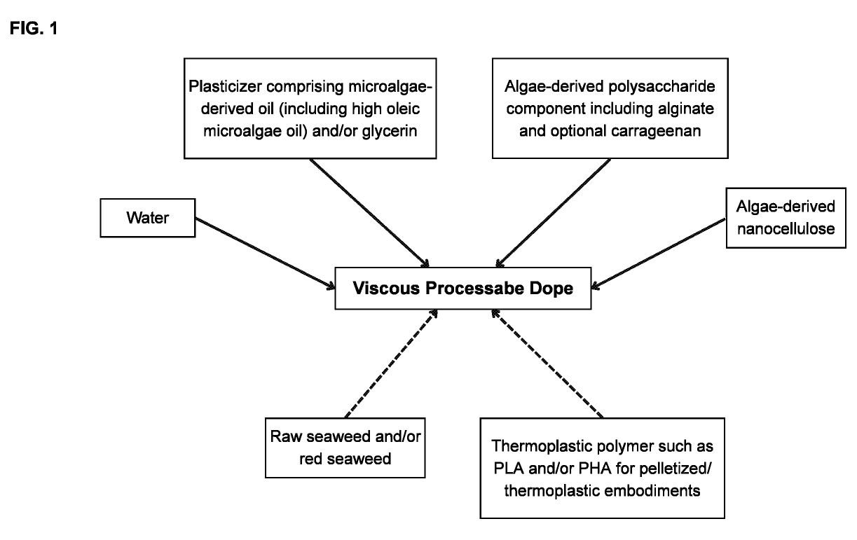

FIGS. 1 – 4 illustrate an algae-based, or algae-derived, formula, according to the invention which is further described herein along with a method of manufacture for rendering the solution into a bioplastic product exhibiting mechanical properties comparable to conventional synthetic polymers used in cordage applications, textiles, films, coatings, and thermoplastics products.

As used herein, “wt.%” refers to weight percent, defined as the percentage by weight of a specified component relative to the total weight of the composition. As used herein, the term “predominantly algae-derived” means that at least 50 wt.% of the non-water solids present in the composition are derived directly or indirectly from macroalgae or microalgae biomass, specifically when formulating for pellets; and at least 90 wt.% of the non-water solids present in the composition are derived directly or indirectly from macroalgae or microalgae biomass, specifically when formulating for fibers. As used herein, the term “nanocellulose” refers to cellulose structures having at least one dimension in the nanoscale range of approximately 1 nm to 500 nm and including cellulose nanofibrils (CNF), cellulose nanocrystals (CNC), or microfibrillated cellulose (MFC). As used herein, the term “dope” refers to a viscous polymer solution or suspension suitable for extrusion, spinning, casting, coating, or other polymer-forming processes. As used herein, “biodegradable” refers to a material capable of biological degradation in marine, soil, fresh water, or compost environments through the action of microorganisms into carbon dioxide, water, methane, or biomass.

In various embodiments, the composition components are selected such that the combined weight percentage of all ingredients totals approximately 100 wt.% ±4 wt.% based on the total composition weight. Optional components may be omitted or substituted provided that the relative proportions maintain a processable polymer composition capable of forming fibers, films, molded articles, or coatings

When mixed into its initial form the formula has the form of a viscous dope. With the exception of water, the ingredients that comprise the formula are predominantly derived from algae. In certain embodiments, the formulation comprises: (i) at least one algae-derived polysaccharide, including alginate; carrageenan; and/or cellulose, including nanocellulose (ii) an algae-derived oil, including a microalgae-derived oil; and (iii) water.

Macroalgae cell walls contain polysaccharides that may be isolated and refined through biorefining processes for use in polymer compositions. In certain embodiments, the formulation comprises alginate extracted from seaweed. Alginate is an anionic polysaccharide capable of ionic crosslinking in the presence of multivalent cations, thus, can enable the formation of fibers and molded products. The renewable origin and intrinsic degradability of alginate highlight its potential use in biodegradable material applications.

In terms of the cellulose, the inventive process uses nanocellulose, which comes from a waste stream of macroalgae processing, to enhance the durability characteristics of the end product that is produced by the method from the formula.

The microalgae is used as a plasticizer, which improves the material’s flexibility and processability. The preferred embodiment uses high oleic microalgae oil as a plasticizer because it has worked the best and is a more sustainable input. In certain embodiments, glycerol may be used as a plasticizer, either alone or in combination with the microalgae-derived oil.

In certain embodiments, the primary structural polymer comprises alginate, optionally combined with carrageenan or other algae-derived polysaccharides, while thermoplastic polymers such as poly(lactic acid) (PLA) or polyhydroxyalkanoates(PHA) are included primarily in pelletized compositions intended for thermoplastic processing

In certain embodiments, the base formulation comprises:
Water: about 20 wt.% to about 98 wt.%
Alginate: about 3 wt.% to about 45 wt.%
Microalgae oil: about 0.1 wt.% to about 5 wt.%
Nanocellulose: about 0.1 wt.% to about 10 wt.%

In some embodiments, the composition may further comprise one or more modifiers selected from:
Red seaweed: about 0.2 wt.% to about 10 wt.%
Carrageenan: about 0.2 wt.% to about 10 wt.%
Polyhydroxyalkanoate (PHA): about 5 wt.% to about 80 wt.%
Glycerin: about 0.1 wt.% to about 5 wt.%
Raw seaweed: about 0.2 wt.% to about 5 wt.%
Polylactic acid (PLA): about 5 wt.% to about 80 wt.%
Strontium bath: about 3 wt.% or greater

Different variations of the formula enable creation of a number of different end products using various techniques, with the specific technique varying depending on the desired end product. For example, higher water concentrations facilitate wet spinning processes by reducing viscosity and improving extrusion stability, whereas pelletization formulations contain lower water content and higher polymer concentrations to facilitate thermoplastic processing.

Mechanical properties of fibers produced according to the present invention may be evaluated using standard tensile testing methods such as ASTM D3822. Biodegradability may be evaluated using marine degradation testing protocols such as ASTM D6691 or equivalent marine biodegradation tests, as well as soil biodegradation standards such as ASTM D5988, freshwater biodegradation standards such as ASTM D5271, and aerobic composting standards such as ASTM D5338 or ASTM D6400, where applicable. In certain embodiments, fibers produced using the disclosed formulations exhibit tenacity greater than approximately 20 cN/tex and elongation at break values greater than 10%.

Mechanical properties of the molded polymer articles produced according to the present invention may be evaluated using standard tensile testing methods such as ASTM D638 and ASTM D695. Biodegradability may be evaluated using marine degradation testing protocols such as ASTM D6691 or equivalent marine biodegradation tests, as well as soil biodegradation standards such as ASTM D5988, freshwater biodegradation standards such as ASTM D5271, and aerobic composting standards such as ASTM D5338 or ASTM D6400, where applicable. In certain embodiments, molded polymers articles produced using the disclosed formulations exhibit a tensile strength greater than 30MPa and flexural modulus greater than 0.1 GPa.

In certain preferred embodiments, the composition comprises: Water: 60–98 wt.%; Alginate: 2–8 wt.%; Nanocellulose: 0.1–6 wt.%; Algae-derived oil or glycerin plasticizer: 0.1–5 wt.%; Optional secondary polysaccharide (e.g., carrageenan): 0.2–5 wt.%.

In other embodiments intended for pelletization or thermoplastic articles, the composition may further comprise: PLA or PHA: 10–60 wt.%; Alginate: 20–40 wt.%; Nanocellulose: 0.1–10 wt.%; Plasticizer: 1–10 wt.%; Water: 5–30 wt.% prior to extrusion drying.

In embodiments suitable for wet spinning, the formulation comprises:

Water: about 45 wt.% to about 98 wt.%

Microalgae oil: about 0.1 wt.% to about 3 wt.%

Nanocellulose: about 0.1 wt.% to about 10 wt.%

Alginate: about 3 wt.% to about 8 wt.%

Carrageenan: about 0.2 wt.% to about 5 wt.%

Raw seaweed: about 0.2 wt.% to about 5 wt.%

Red seaweed: about 0.2 wt.% to about 10 wt.%

Polylactic acid (PLA): about 5 wt.% to about 80 wt.%

Polyhydroxyalkanoate (PHA): about 5 wt.% to about 80 wt.%

Glycerin: about 0.1 wt.% to about 3 wt.%

Wet spinning is a method of manufacture that is used to produce fibers from polymer solutions, typically for textiles, nonwovens, and industrial applications like cordage. This technique involves using the compounded polymer formula in a coagulation bath made using a coagulation bath of multivalent ions. The ions may be provided from salts containing calcium. The liquid is then extruded through spinnerets into the coagulation bath where the polymer precipitates and forms fibers. In general, the wet spinning process requires a lower percentage of water relative to, for example, the pelletization process.

More specifically, the polymer solution is fed into a spinning machine where it is forced through spinnerets, which are devices with multiple tiny holes that shape the solution into continuous filaments, or extruded filaments. The extruded filaments enter a coagulation bath, the solvent is removed or neutralized, causing the polymer to precipitate and solidify, forming distinct fibers. The newly formed fibers are pulled or drawn to align the polymer molecules, enhancing the strength and uniformity of the fibers. The fibers are then washed to remove any residual solvent and non-solvent.

Once the fibers are formed and dried, they are spooled to then be used for things such as textile fibers, yarns, or cordage. The fibers may also be fed into a twisting machine as a means to hold the fibers together, enhancing the strength of the fibers and forming it into a twine/cordage/yarn etc. that have multiple plies. Alternatively, the fibers may also be fed into a braiding machine to be used for twine/cordage/yarn etc. with multiple ends.

Wet spinning may be used to create a number of products from the solution, generally in the form of twines and cordage, and specifically including but not being limited to: multi-ply yarn for any cordage usage or textile functionality; seed string for seaweed cultivators; tubular mesh and netting for fishing, aquaculture, and agriculture applications, including but not limited to bait bags and mussel socks; mesh and netting for fishing, aquaculture, and agriculture applications; baling twine for hay; plant tying and trellis support twine for tomatoes and other vegetables

This wet spinning formula may substitute glycerin for microalgae oil if needed. Blends of alginates having guluronic acid (G) and mannuronic acid (M) content may be employed depending on required flexibility and strength of wet spun output.

### Example 1 – Wet Spinning of Algae-Based Fiber

A polymer dope was prepared by mixing the following components: Water: 84 wt.%; Sodium alginate (low viscosity): 5 wt.%; Nanocellulose fibrils: 3 wt.%; Microalgae oil: 1 wt.%

The mixture was mechanically stirred at approximately 60° C. for approximately 60 minutes until a homogeneous viscous solution was obtained. The polymer dope was degassed and then extruded through a spinneret containing circular apertures having diameters of approximately 100–300 µm.

The extruded filaments were introduced into a coagulation bath comprising an aqueous solution containing approximately 10 wt.% calcium chloride maintained at approximately 20–25° C.

Upon contact with the coagulation bath, ionic crosslinking occurred between the alginate and calcium ions, resulting in formation of continuous fibers.

The fibers were drawn at a draw ratio of approximately 1:1 to 2:0, washed with deionized water, and dried at approximately 50–70° C. Fibers produced by the disclosed process may exhibit mechanical properties suitable for cordage, yarn, or textile applications.

### Example 2 – Preparation of Algae-Based Articles

A polymer dope was prepared by mixing the following components: Water: 30 wt.%; Sodium alginate: 30 wt.%; Nanocellulose fibrils: 5 wt.%; Microalgae oil: 5 wt.%; Carrageenan: 5 wt.% and a slow-release multivalent crosslinking agent: 10%.

In certain embodiments, the ion may be provided in an encapsulated form of calcium lactate. The encapsulation may allow for controlled release of the ions during the thermal processing.

An alternative process is nurdled pelletization, where pelletized nurdles take the form of small beads that serve as the raw material feedstock to a range of manufacturing processes that make a variety of products.

In embodiments suitable for pelletization, the formulation comprises:

Water: about 10wt.% to about 40 wt.%

Microalgae oil: about 0.1 wt.% to about 8 wt.%

Nanocellulose: about 0.1 wt.% to about 10 wt.%

Alginate: about 20 wt.% to about 40 wt.%

Carrageenan: about 0.2 wt.% to about 8 wt.%

Raw seaweed: about 0.2 wt.% to about 5 wt.%

Red seaweed: about 0.2 wt.% to about 10 wt.%

Polylactic acid (PLA): about 5 wt.% to about 80 wt.%

Polyhydroxyalkanoate (PHA): about 5 wt.% to about 80 wt.%

Glycerin: about 0.1 wt.% to about 8 wt.%

Encapsulated calcium lactate: about 20 wt.% to about 40 wt.%

This formula benefits from an additional raw red seaweed powder and an additional variation of alginate, which means it has two types of alginate powder in the compound, high G and high M. This formula may also substitute glycerin for microalgae oil.

In certain embodiments, the formulation is pelletized by feeding the dope into an extruder with a multivalent crosslinker incorporated in a latent form and later released within the polymer matrix. The polymer goes through the extruder which creates one continuous extrudate. The extrudate is cooled and then cut into 3-5 mm diameter pieces.

In a second such process, the raw polymer solution is sent through multiple extruders or larger droppers. The polymer solution is then dropped at an equal amount into the coagulation bath, creating pellets, which are then washed and dried.

These pelletized nurdles, or in certain embodiments the extrudate, may then subsequently be put through various plastic manufacturing processes, such as injection molding, blow molding, or extrusion, in order to create a number of different end products, such as cable ties, medical devices, household items, and packaging containers.

In certain embodiments, the formulation is compounded and pelletized prior to molding. The components may be mixed in an extruder at temperatures below 65° C. to maintain the latent crosslinker, such as encapsulated calcium lactate, in an inactive state. The pellets may then be processed by injection molding, extrusion, or blow molding. During molding, heating may release the encapsulated crosslinking ions in a temperature range from 70-180° C.

The polymer dispersion may also be used to create a polymer film, with embodiments suitable for film formation, the formulation comprises:

Water: about 10 wt.% to about 75 wt.%

Microalgae oil: about 0.1 wt.% to about 5 wt.%

Nanocellulose: about 1 wt.% to about 10 wt.%

Alginate: about 3 wt.% or greater

Carrageenan: about 0.2 wt.% to about 8 wt.%

Raw seaweed: about 0.2 wt.% to about 5 wt.%

Red seaweed: about 0.2 wt.% to about 10 wt.%

Polylactic acid (PLA): about 5 wt.% to about 80 wt.%

Polyhydroxyalkanoate (PHA): about 5 wt.% to about 80 wt.%

Glycerin: about 0.1 wt.% to about 5 wt.%

Such a film may be created via a film casting process, blown extrusion, or, but not limited to, roll-to-roll coating process. In these processes, the polymer is deposited, spread or extruded into a thin layer and dried or crosslinked to form a film. The specific formulation may vary slightly from the previous embodiments.

Finally, the polymer solution may also be used to create a polymer coating. In embodiments suitable for coatings, the formulation comprises:

Water: about 50 wt.% to about 95 wt.%

Microalgae oil: about 0.1 wt.% to about 8 wt.%

Nanocellulose: about 1 wt.% to about 8 wt.%

Alginate: about 3 wt.% to about 6 wt.%

Carrageenan: about 0.2 wt.% to about 5 wt.%

Raw seaweed: about 0.2 wt.% to about 5 wt.%

Red seaweed: about 0.2 wt.% to about 10 wt.%

Polylactic acid (PLA): about 5 wt.% to about 80 wt.%

Polyhydroxyalkanoate (PHA): about 5 wt.% to about 80 wt.%

Glycerin: about 0.1 wt.% to about 5 wt.%

Again, a specific formulation is mixed and then applied to a substrate in a conventional manner. For example, the following methods may be used, but are not limited to: 1) spray coating, in which the solution is dispersed onto a substrate by spraying it through a spray system; 2) dip coating, in which the substrate is dipped into a bath of the solution; or 3) roller coating, in which a roller spreads the solution across a substrate. In each case, the solution is allowed to dry, either by allowing it to air dry or by applying a drying method. The resulting coating may then be cured or otherwise treated as desired or necessary.

### Example 3 – Preparation of Algae-Based Coating

A polymer dope was prepared by mixing the following components: Water: 84 wt.%; Sodium alginate (low viscosity): 5 wt.%; Nanocellulose fibrils: 5 wt.%; Microalgae oil: 1 wt.%

In certain embodiments the polymer is dispersed in water by a high-shear mixing (5000 - 20000 RPM). The suspension may be degassed under vacuum prior to coating. The dispersion is then applied onto a substrate using a doctor blade coating method. In certain embodiments a crosslinker solution comprising Calcium Chloride 1-15wt.% is sprayed on the coating. The sample is then dried at 60-100° C. Coating thickness may be characterized by cross-section measurements using Scanning Electron Microscope (SEM) images. Mechanical Properties may be evaluated ASTM D882 and barrier properties such as oxygen permeability, and grease resistance may be evaluated by ASTM D3985 and TAPPI T559m respectively.

In certain embodiments, emulsifiers or compatibilizers may be used to improve dispersion between hydrophilic polysaccharides and hydrophobic thermoplastics such as PLA or PHA, and related biodegradable polymers

With both the film and coating formulas, the formula has a lower percentage of alginate, typically between 3 and 6%, and may use a variation of additional inputs into the compound depending on the use case for the film. Additional inputs may be carrageenan, PLA, PHA, or PHB. This formula may also substitute glycerin for microalgae oil.

### Example 4 – Preparation of Algae-Based Films

A polymer dope was prepared by mixing the following components: Water: 84 wt.%; Sodium alginate: 5 wt.%; Nanocellulose fibrils: 5 wt.%; Microalgae oil: 1 wt.%

In certain embodiments the polymer is dispersed in water by a high-shear mixing (5000 - 20000 RPM). The suspension may be degassed under vacuum prior to casting. The dispersion is then cast on a flat substrate. In certain embodiments the films are immersed in a crosslinking bath comprising a solution of Calcium Chloride 1-15 wt.%. The sample is then dried at 60-100° C. Film thickness may be characterized by crosssection measurements using Scanning Electron Microscope (SEM) images or with a caliper. Mechanical Properties may be evaluated ASTM D882 and barrier properties such as oxygen permeability, and grease resistance may be evaluated by ASTM D3985 and TAPPI T559m respectively

The specific ratio of ingredients in the solution, as well as the addition of certain additives, may vary depending on the manufacturing process as well as the desired end product.

It is understood that the embodiments described herein are merely illustrative of the present invention. Variations in the formula and method may be contemplated by one skilled in art without limiting the intended scope of the invention herein disclosed.

1. A bioplastic composition comprising:water;an algae-derived polysaccharide component comprising alginate;algae-derived nanocellulose;and a plasticizer comprising a microalgae-derived oil and/or glycerin;wherein the bioplastic composition is a dope suitable for extrusion, spinning, casting, coating, and/or molding, and wherein the bioplastic composition is predominantly algae-derived such that at least 50 wt. % of non-water solids in the bioplastic composition are derived directly or indirectly from macroalgae or microalgae biomass.

2. The bioplastic composition of claim 1, wherein the algae-derived polysaccharide component further comprises carrageenan.

3. The bioplastic composition of claim 1, wherein the plasticizer comprises a high oleic microalgae oil.

4. The bioplastic composition of claim 1, wherein the plasticizer comprises glycerin.

5. The bioplastic composition of claim 1, wherein the algae-derived nanocellulose comprises cellulose nanofibrils, cellulose nanocrystals, microfibrillated cellulose, or a combination thereof.

6. The bioplastic composition of claim 1, wherein the bioplastic composition comprises, by weight percent based on total composition weight:
water in an amount of 20 wt. % to 98 wt. %;
the microalgae-derived oil in an amount of 0.1 wt. % to 5 wt. %;
the algae-derived nanocellulose in an amount of 0.1 wt. % to 10 wt. %; and
the alginate in an amount of 3 wt. % to 45 wt. %.

7. The bioplastic composition of claim 1, further comprising raw seaweed in an amount of 0.2 wt. % to 10 wt. % and/or red seaweed in an amount of 0.2 wt. % to 10 wt. %.

8. The bioplastic composition of claim 1, further comprising polylactic acid (PLA) and/or polyhydroxyalkanoate (PHA).

9. The bioplastic composition of claim 1, wherein the bioplastic composition is configured for wet spinning and comprises, by weight percent based on total composition weight:
water in an amount of 45 wt. % to 98 wt. %;
microalgae-derived oil in an amount of 0.1 wt. % to 3 wt. %;
algae-derived nanocellulose in an amount of 0.1 wt. % to 10 wt. %; and
alginate in an amount of 3 wt. % to 8 wt. %.

10. The bioplastic composition of claim 1, wherein the bioplastic composition is configured for compounding and/or thermal extrusion and comprises, by weight percent based on total composition weight:
water in an amount of 10wt. % to 40 wt. %;
microalgae-derived oil in an amount of 0.1 wt. % to 8 wt. %;
algae-derived nanocellulose in an amount of 0.1 wt. % to 10 wt. %;
alginate in an amount of 20wt. % to 40 wt. % and a latent multivalent crosslinker of 1 wt. % to 20 wt.%.

11. (canceled)

12. (canceled)

13. (canceled)

14. (canceled)

15. (canceled)

16. (canceled)

17. (canceled)

18. (canceled)

19. (canceled)
